(19) United States
(12) Patent Application Publication
(10) Pub. No.: US 2026/0351277 A1
(43) Pub. Date: Nov. 5, 2026

(54) DETECTION OF AUDIO BROADCASTING BY MEETING ATTENDEES

(71) Applicant: International Business Machines Corporation, Armonk, NY (US)

(72) Inventors: Erik RUEGER, Ockenheim (DE); Paritosh RANJAN, Kolkata (IN); Prodip ROY, Kolkata (IN); Bhubaneswar PADHAN, KOLKATA (IN)

(21) Appl. No.: 19/195,495

(22) Filed: Apr. 30, 2025

(51) Int. Cl. G10L 25/51; G10L 15/06; H04L 12/18

(52) U.S. Cl. CPC G10L 25/51; G10L 15/063; H04L 12/1895

(57) ABSTRACT

In some implementations, a device may obtain a first representation of meeting audio output generated during a meeting by meeting software. The device may generate a second representation of raw audio output from a speaker of the device that is captured by a microphone of the device during the meeting. The device may determine whether the device is broadcasting the meeting audio output based on a result of a comparison of the first representation and the second representation. The device may output an indication that the device is broadcasting the meeting audio output.

### BACKGROUND

This disclosure relates to collaborative communications, and more specifically, to online meetings or voice calls.

### SUMMARY

Some aspects described herein relate to a method. The method may include obtaining, by a device, a first representation of meeting audio output generated during a meeting by meeting software. The method may include generating, by the device, a second representation of raw audio output from a speaker of the device that is captured by a microphone of the device during the meeting. The method may include determining, by the device, whether the device is broadcasting the meeting audio output based on a result of a comparison of the first representation and the second representation. The method may include outputting, by the device, an indication that the device is broadcasting the meeting audio output.

Some aspects described herein relate to a computer system. The computer system may include a processor set, one or more computer-readable storage media, and program instructions stored on the one or more computer-readable storage media to cause the processor set to perform operations. The operations may include receiving, by the computer system during a meeting, a first representation of meeting audio output of the meeting from a meeting server. The operations may include capturing, by a microphone of the computer system during the meeting, raw audio output from a speaker of the computer system. The operations may include generating, by the computer system, a second representation of the raw audio output. The operations may include comparing, by the computer system, the first representation and the second representation to determine whether the computer system is broadcasting the meeting audio output. The operations may include outputting, by the computer system, an indication that the computer system is broadcasting the meeting audio output.

Some aspects described herein relate to a computer program product. The computer program product may include one or more computer-readable storage media and program instructions stored on the one or more computer-readable storage media to perform operations. The operations may include evaluating, by a device, a first transcript of meeting audio output generated during a meeting and a second transcript of raw audio captured by a microphone of the device. The operations may include comparing the first transcript and the second transcript using a similarity algorithm. The operations may include determining, by the device, whether the device is broadcasting the meeting audio output, based on a result of the comparison. The operations may include outputting, by the device, an indication that the device is broadcasting the meeting audio output.

### BRIEF DESCRIPTION OF THE DRAWINGS

FIG. 1 is a diagram of an example computing environment for detection of audio broadcasting by meeting attendees.

FIG. 2 is a diagram of an example of meeting audio that is being broadcast for others to hear.

FIG. 3 is a diagram of an example implementation associated with a computer system or computer device for detecting whether meeting audio is being broadcast on a speaker where non-attendees could hear.

FIG. 4 is a diagram illustrating an example meeting interface with broadcast alert icons.

FIG. 5 is a diagram illustrating an example meeting interface with a broadcast alert icon.

FIG. 6 is a flowchart of an example process associated with detection of audio broadcasting by meeting attendees.

FIG. 7 is a flowchart of an example process associated with detection of audio broadcasting by meeting attendees.

FIG. 8 is a flowchart of an example process associated with detection of audio broadcasting by meeting attendees.

### DETAILED DESCRIPTION

The following detailed description of example implementations refers to the accompanying drawings. The same reference numbers in different drawings may identify the same or similar elements.

In recent years, the rise of remote work and online communication has led to an increase in virtual meetings and phone calls. While convenient, these types of interactions can pose significant risks to confidentiality and data security. One major concern is the potential for unauthorized individuals to overhear sensitive information, particularly when meeting attendees use loudspeakers or fail to properly secure their audio connections. Sensitive information may include personal information, health information, financial information, business information, strategy details, or information related to physical security or digital security.

Currently, it is up to individual attendees to ensure that their audio settings are configured correctly and that they are using headphones or other discreet listening methods. However, this approach has several limitations. For instance, attendees may forget to check their settings or may intentionally broadcast meeting audio without informing the other participants. Moreover, the lack of clear visibility into who is listening to the meeting audio can create an environment where sensitive information is inadvertently shared with unauthorized parties.

Some implementations described herein provide a computer device that detects or accelerates the detection of a device that is broadcasting meeting audio on a speaker. For example, the computer device may obtain a first representation (e.g., transcript, text sample) of meeting audio output generated during a meeting by meeting software, and may generate a second representation of raw audio output from a speaker of the device that is captured by a microphone of the device during the meeting. The device may determine whether the device is broadcasting the meeting audio output by comparing of the first representation and the second representation for similarity. For example, if a meeting audio transcript and a raw audio transcript are sufficiently similar, the device may output an indication to other meeting attendees that the device is broadcasting the meeting audio output.

In some aspects, the comparison may use a similarity algorithm to calculate a similarity score, and the device may determine whether the device is broadcasting the meeting audio output based on the similarity score satisfying a similarity threshold. The similarity threshold may be trained based on raw audio that is indicated as being broadcast, including raw audio from multiple attendees.

In this way, the device may reduce processing latency associated with detecting a device broadcasting meeting audio. For example, by comparing the two transcripts (or two text samples), the device may reduce the computational overhead necessary to process audio data to identify whether a meeting attendee is broadcasting meeting audio. This accelerated detection algorithm may include techniques for reducing the dimensionality of the audio data and/or optimizing the similarity calculation process, thereby conserving processing resources, memory resources, network resources, and/or the like. Thus, the computer device may also minimize the memory footprint of the detection process, and reduce the amount of network bandwidth consumed by transmission of unauthorized broadcast notifications.

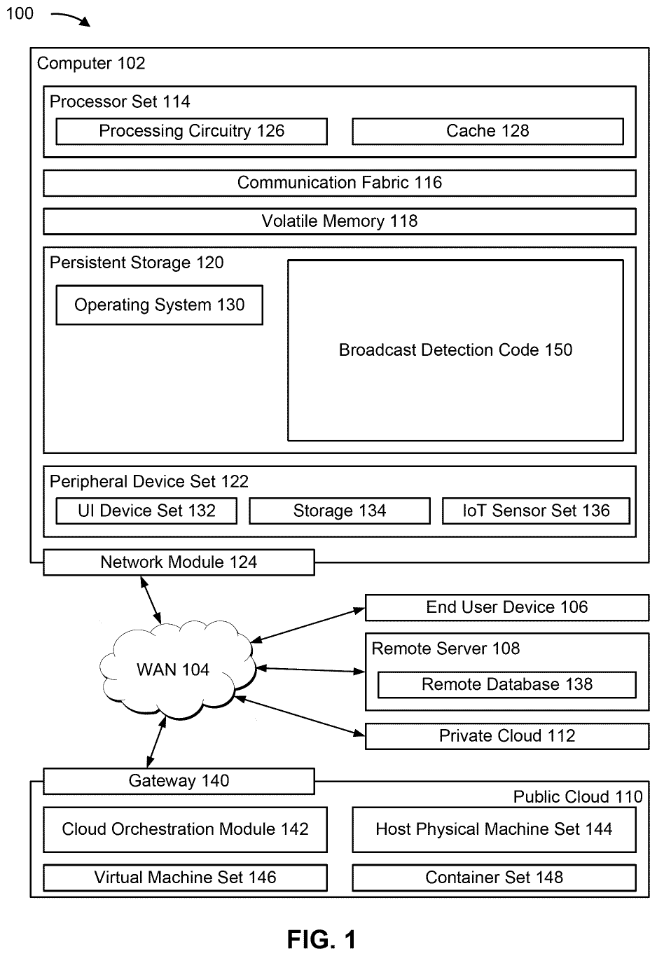

FIG. 1 is a diagram of an example computing environment 100 for detection of audio broadcasting by meeting attendees.

The computing environment 100 contains an example of an environment for the execution of at least some of the computer code involved in performing the inventive methods, such as broadcast detection code 150. In addition to the broadcast detection code 150, the computing environment 100 includes, for example, a computer 102, a wide area network (WAN) 104, an end user device (EUD) 106, a remote server 108, a public cloud 110, and a private cloud 112. In this embodiment, the computer 102 includes a processor set 114 (including processing circuitry 126 and a cache 128), communication fabric 116, volatile memory 118, persistent storage 120 (including an operating system 130 and the broadcast detection code 150, as identified above), a peripheral device set 122 (including a user interface (UI) device set 132, storage 134, and an Internet of Things (IoT) sensor set 136), and a network module 124. The remote server 108 includes a remote database 138. The public cloud 110 includes a gateway 140, a cloud orchestration module 142, a host physical machine set 144, a virtual machine set 146, and a container set 148.

The computer 102 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as the remote database 138. As is well understood in the art of computer technology, and depending upon the technology, performance of a computer-implemented method may be distributed among multiple computers and/or between multiple locations. On the other hand, in this presentation of the computing environment 100, detailed discussion is focused on a single computer, specifically the computer 102, to keep the presentation as simple as possible. The computer 102 may be located in a cloud, even though it is not shown in a cloud in FIG. 1. On the other hand, the computer 102 is not required to be in a cloud except to any extent as may be affirmatively indicated.

Computer-readable program instructions are typically loaded onto the computer 102 to cause a series of operational steps to be performed by the processor set 114 of the computer 102 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as the cache 128 and the other storage media discussed below. The program instructions, and associated data, are accessed by the processor set 114 to control and direct performance of the inventive methods. In the computing environment 100, at least some of the instructions for performing the inventive methods may be stored in broadcast detection code 150 in the persistent storage 120.

The communication fabric 116 is the signal conduction path that allows the various components of the computer 102 to communicate with each other. Typically, this fabric is made of switches and electrically conductive paths, such as the switches and electrically conductive paths that make up buses, bridges, and/or physical input/output ports, among other examples. Other types of signal communication paths may be used, such as fiber optic communication paths and/or wireless communication paths, among other examples.

The volatile memory 118 is any type of volatile memory now known or to be developed in the future. Examples include dynamic type random access memory (RAM) or static type RAM. Typically, the volatile memory 118 is characterized by random access, but this is not required unless affirmatively indicated. In the computer 102, the volatile memory 118 is located in a single package and is internal to the computer 102, but, alternatively or additionally, the volatile memory 118 may be distributed over multiple packages and/or located externally with respect to the computer 102.

The code included in the broadcast detection code 150 typically includes at least some of the computer code involved in performing one or more operations described herein. The operations may include, for example, obtaining a first representation of meeting audio output generated during a meeting by meeting software; generating a second representation of raw audio output from a speaker of the device that is captured by a microphone of the device during the meeting; determining whether the device is broadcasting the meeting audio output based on a result of a comparison of the first representation and the second representation; and outputting an indication that the device is broadcasting the meeting audio output.

In some implementations, the operations may include receiving a first representation of meeting audio output of the meeting from a meeting server; capture raw audio output from a speaker of the computer system; generating a second representation of the raw audio output; comparing the first representation and the second representation to determine whether the computer system is broadcasting the meeting audio output; and outputting an indication that the computer system is broadcasting the meeting audio output.

In some implementations, the operations may include evaluating a first transcript of meeting audio output generated during a meeting and a second transcript of raw audio captured by a microphone of the device; comparing the first transcript and the second transcript using a similarity algorithm; determining whether the device is broadcasting the meeting audio output, based on a result of the comparison; and outputting an indication that the device is broadcasting the meeting audio output.

The peripheral device set 122 includes the set of peripheral devices of the computer 102. Data communication connections between the peripheral devices and the other components of the computer 102 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, the UI device set 132 may include components such as a display screen, speaker, microphone, wearable devices (such as goggles and smart watches), keyboard, mouse, printer, touchpad, game controllers, and haptic devices. The storage 134 is external storage, such as an external hard drive, or insertable storage, such as an SD card. The storage 134 may be persistent and/or volatile. In some embodiments, the storage 134 may take the form of a quantum computing storage device for storing data in the form of qubits. In embodiments where the computer 102 is required to have a large amount of storage (for example, where the computer 102 locally stores and manages a large database), then this storage may be provided by peripheral storage devices designed for storing very large amounts of data, such as a storage area network (SAN) that is shared by multiple, geographically distributed computers. The IoT sensor set 136 is made up of sensors that can be used in Internet of Things applications. For example, one sensor may be a thermometer and another sensor may be a motion detector.

The network module 124 is the collection of computer software, hardware, and firmware that allows the computer 102 to communicate with other computers through the WAN 104. The network module 124 may include hardware, such as modems or Wi-Fi signal transceivers, software for packetizing and/or de-packetizing data for communication network transmission, and/or web browser software for communicating data over the internet. In some embodiments, network control functions and network forwarding functions of the network module 124 are performed on the same physical hardware device. In other embodiments (for example, embodiments that utilize software-defined networking (SDN)), the control functions and the forwarding functions of the network module 124 are performed on physically separate devices, such that the control functions manage several different network hardware devices. Computer-readable program instructions for performing the inventive methods can typically be downloaded to the computer 102 from an external computer or external storage device through a network adapter card or network interface included in the network module 124.

The WAN 104 is any wide area network (for example, the internet) capable of communicating computer data over non-local distances by any technology for communicating computer data, now known or to be developed in the future. In some embodiments, the WAN 104 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and/or edge servers, among other examples.

The EUD 106 is any computer system that is used and controlled by an end user (for example, a customer of an enterprise that operates the computer 102), and may take any of the forms discussed above in connection with the computer 102. The EUD 106 typically receives helpful and useful data from the operations of the computer 102. For example, in a hypothetical case where the computer 102 is designed to provide a recommendation to an end user, this recommendation would typically be communicated from the network module 124 of the computer 102 through the WAN 104 to the EUD 106. In this way, the EUD 106 can display, or otherwise present, the recommendation to an end user. In some embodiments, the EUD 106 may be a client device, such as thin client, heavy client, mainframe computer, and/or desktop computer, among other examples.

The remote server 108 is any computer system that serves at least some data and/or functionality to the computer 102. The remote server 108 may be controlled and used by the same entity that operates the computer 102. The remote server 108 represents the machine(s) that collect and store helpful and useful data for use by other computers, such as the computer 102. For example, in a hypothetical case where the computer 102 is designed and programmed to provide a recommendation based on historical data, then this historical data may be provided to the computer 102 from the remote database 138 of the remote server 108.

The public cloud 110 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of the public cloud 110 is performed by the computer hardware and/or software of the cloud orchestration module 142. The computing resources provided by the public cloud 110 are typically implemented by virtual computing environments that run on various computers making up the computers of the host physical machine set 144, which is the universe of physical computers in and/or available to the public cloud 110. The virtual computing environments (VCEs) typically take the form of virtual machines from the virtual machine set 146 and/or containers from the container set 148. It is understood that these VCEs may be stored as images and may be transferred among and between the various physical machine hosts, either as images or after instantiation of the VCE. The cloud orchestration module 142 manages the transfer and storage of images, deploys new instantiations of VCEs and manages active instantiations of VCE deployments. The gateway 140 is the collection of computer software, hardware, and firmware that allows the public cloud 110 to communicate through the WAN 104.

Some further explanation of VCEs will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

The private cloud 112 is similar to the public cloud 110, except that the computing resources are only available for use by a single enterprise. While the private cloud 112 is depicted as being in communication with the WAN 104, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, the public cloud 110 and the private cloud 112 are both part of a larger hybrid cloud.

Cloud computing services and/or microservices (not separately shown in FIG. 1): private cloud 112 and public clouds 110 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of application programming interfaces (APIs). One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

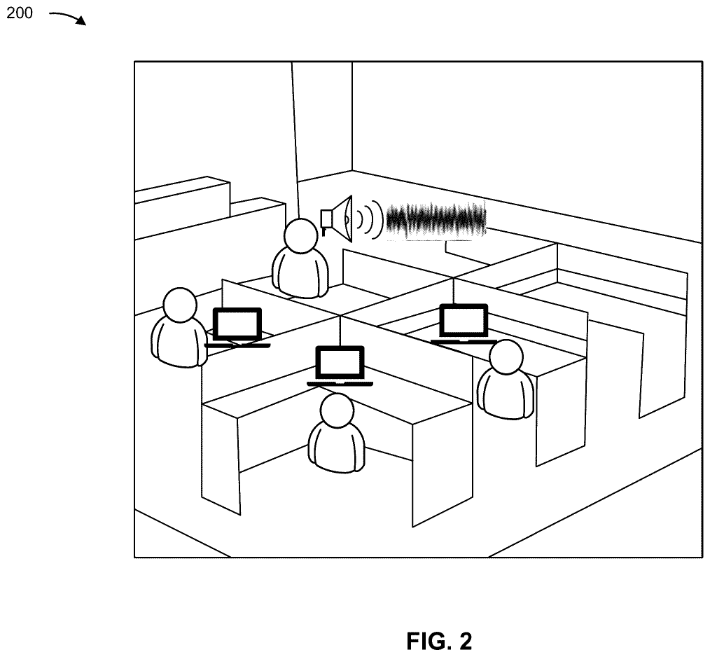

FIG. 2 is a diagram of an example 200 where meeting audio is being broadcast for others to hear. If a meeting attendee is listening to meeting audio through a device's speaker (without using headphones) or has a phone on speaker mode, the audio can be easily overheard by others in the surrounding area. This means that anyone within earshot of the device or phone can potentially hear the meeting conversation, including sensitive or confidential information being discussed. This can pose a security risk, especially if the meeting is being held in a public or shared space, such as a coffee shop, open office area, or public transportation. This risk may be in contrast to a meeting attendee listening without headphones in a private setting, such as an office, room, or space where non-attendees are unable to hear the meeting audio output. In other scenarios, an attendee may not be aware that a jack of a headset is connected loosely to the meeting device, and the device continues to broadcast the sound both to the headset and the loudspeaker. The attendee is under the impression that the conversation is private, but the conversation is not.

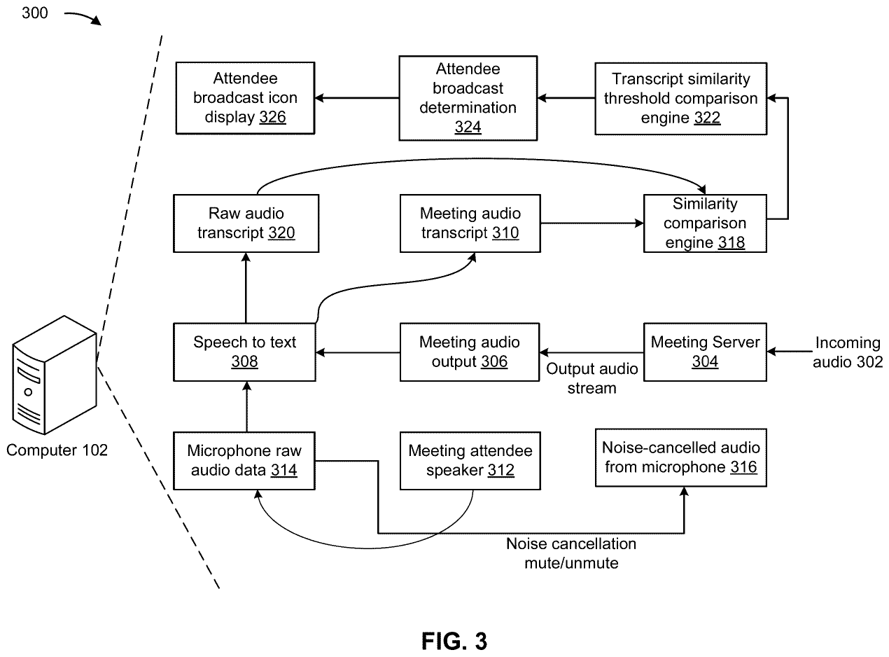

FIG. 3 is a diagram of an example implementation 300 associated with a computer system or computer device for detecting whether meeting audio is being broadcast (played out loud) on a speaker where non-attendees could hear.

As shown by implementation 300, a computer device (e.g., computer 102) may run virtual meeting software that enables multiple users to attend a virtual or online meeting. Meeting attendees can join the meeting using their computer device's audio and video capabilities. Meeting attendees can listen to the meeting through computer speakers or headphones. Alternatively, an attendee can dial into the meeting using a phone number provided by the meeting host, allowing the attendee to listen to the meeting via a traditional phone line. The phone may use a mobile application that provides the virtual meeting software for attending the meeting.

Some implementations described herein provide a computer device that detects whether a device is broadcasting meeting audio (e.g., speech). For example, the device may obtain a first representation (e.g., transcript, recording) of meeting audio output generated during a meeting by meeting software, and may generate a second representation of raw audio output from a speaker of the device that is captured by a microphone of the device during the meeting. The device may determine whether the device is broadcasting the meeting audio output based on a result of a comparison of the first representation and the second representation, and may output an indication that the device is broadcasting the meeting audio output.

Implementation 300 shows incoming audio 302 (e.g., speech from meeting captured via microphone) and components for detecting whether the speech is being broadcast on a device speaker of a meeting attendee. The incoming audio 302 may be streamed from a device of a meeting presenter to the meeting server 304, which is associated with the meeting software that manages the online meeting. The audio from the presenter may be received using a noise-cancelling microphone at the device, to produce noise-cancelled audio 316 from the microphone. The audio of each attendee may also be received at the meeting server 304. The meeting audio from the incoming streams from the devices may be combined and output as an output audio stream (media audio output 306) to the device of each meeting attendee. The meeting server 304 or the individual devices may generate a representation of the media audio output 306 from the meeting server 304. The representation may include a meeting audio transcript 310 generated via a speech to text component 308.

If a meeting attendee is listening to the meeting audio through a device's speaker (without using headphones) or has their phone on speaker mode, the audio can be easily overheard by others in the surrounding area. Accordingly, while the device is obtaining (e.g., generating or receiving) the meeting audio transcript 310 during the meeting, meeting audio that is broadcast on a meeting attendee speaker 312 (e.g., loudspeaker) of the device may be recorded on a microphone of the same device, as microphone raw audio data 314. The audio can be emitting from an in-built speaker of the attendee's device, a speaker connected via a Bluetooth® protocol, or a speaker connected to the device via a jack or universal serial bus (USB).

The device may, via the speech to text component 308, generate a speaker/microphone audio transcript (raw audio transcript 320) for the microphone raw audio data 314. That is, the transcripts may be generated in real time for comparison during the meeting. The device may generate a transcript for the last t_{buffer} seconds of meeting audio that is stored locally on the attendee's device, or a sufficient amount to determine if the meeting audio is being broadcast on a speaker, in order to provide a timely notice of the broadcast of the meeting audio to other attendees. In some implementations, the device may generate a sample text, which may include certain words, phrases, or portions of transcribed text for comparison that may not necessarily be a word-for-word transcription of the meeting conversation. That is, a representation may be some textual record of the meeting audio that is designed for a text-to-text comparison. The transcript or text sample may, in some examples, be only a few words, a couple of sentences, or a longer stream of text.

The device may compare the meeting audio transcript 310 and the raw audio transcript 320 to determine that the meeting audio is being broadcast loud enough so as to be picked up on the computer microphone at a level (e.g., threshold minimum) that could compromise the security of the information provided during the meeting. For example, if the transcripts are similar enough, this could indicate that the meeting audio is being broadcast. The device may also compare text samples.

In some implementations, the device may be configured with a comparison engine (e.g., similarity comparison engine 318), or more specifically, a transcript similarity threshold comparison engine 322, that uses a similarity algorithm to detect the amount of similarity between the transcripts (or text samples). For example, the similarity algorithm may calculate a similarity score based on the differences between the two transcripts. The similarity score is then used to determine whether the device is broadcasting the meeting audio output, as shown by attendee broadcast determination 324. The similarity score may be calculated based on, for example, what percentage of words are the same between the transcripts for a period of time.

Additionally, or alternatively, the device may use a similarity threshold to determine whether the device is broadcasting the meeting audio output. If the similarity score satisfies (e.g., meet or exceeds) the similarity threshold, the device may determine that the meeting audio output is being broadcast. The similarity threshold may be determined based on a predefined value that is set during a training process. The device may adjust the similarity threshold based on the similarity score calculated for each comparison. The device may adjust the similarity threshold to optimize the accuracy of the detection.

In an example, the device may compare the transcripts using text similarity algorithms such as a Levenshtein distance algorithm, a term frequency-inverse document frequency (TF-IDF) algorithm, or a distance between clusters algorithm. The speech similarity score may be the text parameters from the meeting server minus the text parameters from the attendee microphone. The text comparison may be performed for batches of t_{batch} seconds. If the text similarity score is greater than a certain threshold thₛᵢₘᵢₗₐᵣ, then the attendee is considered to be broadcasting (playing) the meeting audio on the loudspeaker of the device. For example, if Speech_{SimilarityScore}>thₛᵢₘᵢₗₐᵣ, then BROADCAST=TRUE, and if Speech_{SimilarityScore}<=thₛᵢₘᵢₗₐᵣ, then BROADCAST=FALSE.

Additionally, or alternatively, the system can use multiple similarity threshold values to determine if the attendee is broadcasting the meeting audio. For example, a higher threshold value may be used in noisy environments, while a lower threshold value may be used in quieter environments. The similarity algorithm used to compare the meeting audio transcript and the raw audio transcript is optimized to reduce computational overhead, conserving processing resources and minimizing latency.

The device that is broadcasting meeting audio (and any other attendee devices broadcasting meeting audio on a speaker) may output an indication to the meeting server, which transmits indications to each attendee, indicating which attendees are broadcasting the meeting audio on a speaker that non-attendees can hear. In some implementations, each device may transmit the indications directly to the other devices. Each device associated with the meeting may display an alert icon on its display (e.g., attendee broadcast icon display 326) when an indication is received that the meeting audio output is being broadcast on another device. For example, the device may display an attendee broadcast icon in a meeting interface, shown at 326, and may identify the other devices that are broadcasting the meeting audio.

In some implementations, the device may detect broadcasting of audio output in multiple environments. For example, the device adjusts the similarity threshold and the machine learning model used for the similarity score calculation based on factors such as the type of environment, the number of devices present, and the level of background noise. In some implementations, the device may repeat the evaluations for multiple iterations to continuously monitor and detect whether the device is broadcasting the meeting audio output.

In some implementations, the system may include a feature where attendees can declare when the attendee is using a loudspeaker of a device to listen to the meeting audio. This declaration may be used to train the threshold value for determining if the attendee is broadcasting the meeting audio. The attendee devices that have declared using a loudspeaker for listening to the meeting audio, the thₛᵢₘᵢₗₐᵣ value may be generated and shared with the meeting server as a collective intelligence method to determine the best possible value of thₛᵢₘᵢₗₐᵣ. By comparing text transcripts instead of raw audio data, the algorithm reduces the computational complexity of the comparison process, conserving processing resources and minimizing latency.

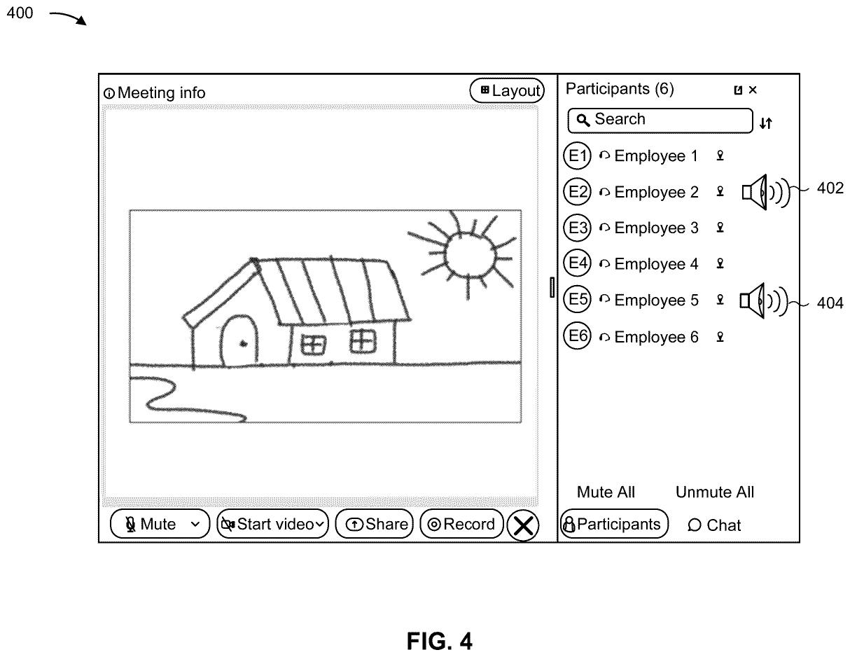

FIG. 4 is a diagram illustrating an example meeting interface 400 with broadcast alert icons. The meeting software user interface may show an icon of a loudspeaker next to the attendees who are detected as using a loudspeaker to listen to the meeting audio. The device may show a broadcast alert icon if BROADCAST=TRUE, or not show a broadcast alert icon if BROADCAST=FALSE.

The meeting interface 400 shows an image that is being presented, as well as the meeting attendees. Of the meeting attendees, employees 2 and 5 are indicated as broadcasting the meeting audio, as shown by icon 402 and icon 404. The host or attendee in charge of the meeting may remind or verify that the attendees are protecting the information of the meeting.

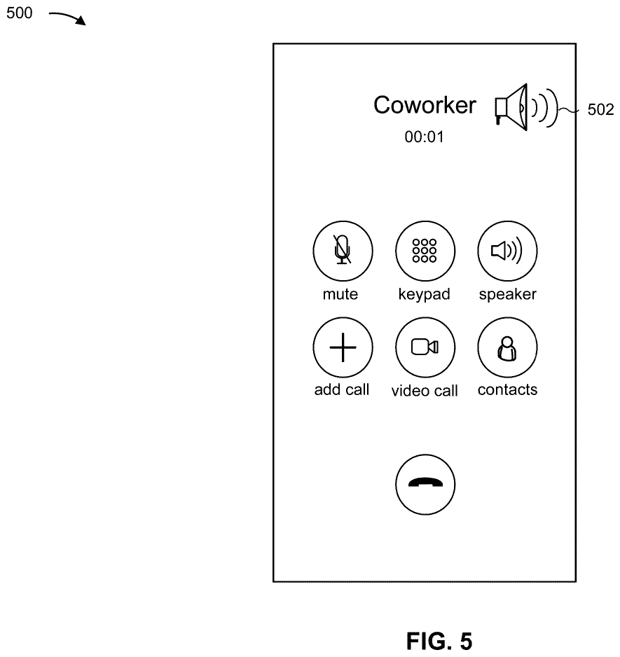

FIG. 5 is a diagram illustrating an example meeting interface 500 with a broadcast alert icon. The meeting associated with FIG. 5 is a voice call with another coworker. The interface 500 shows voice call icons, including an alert icon 502 that indicates that the coworker is broadcasting the meeting audio, which may include placing the call in speaker mode. The caller may remind or verify that the other caller is protecting the information of the meeting. As a result, the security of meeting information is protected.

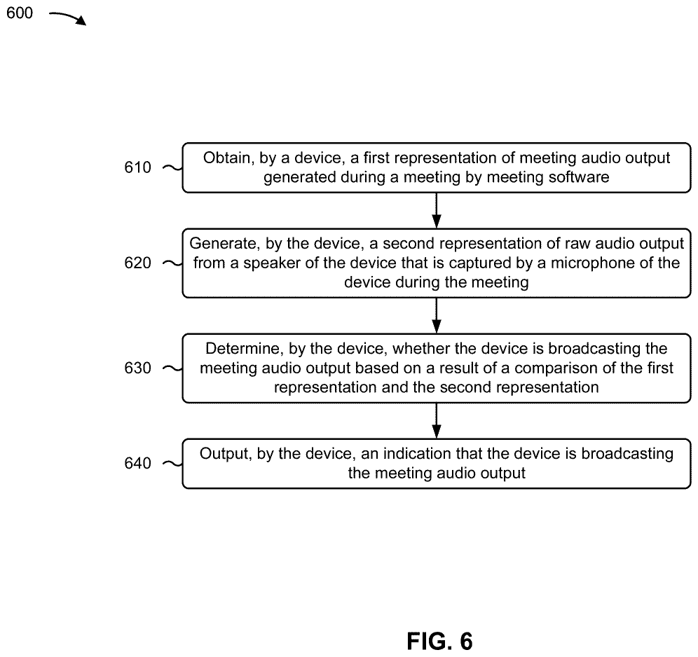

FIG. 6 is a flowchart of an example process 600 associated with detection of audio broadcasting by meeting attendees. One or more process blocks of FIG. 6 are performed by a device (e.g., computer 102) and/or by another device or a group of devices separate from or including the device.

As shown in FIG. 6, process 600 includes obtaining a first representation of meeting audio output generated during a meeting by meeting software (block 610). For example, the device may obtain a first representation of meeting audio output generated during a meeting by meeting software, as described above.

As further shown in FIG. 6, process 600 includes generating a second representation of raw audio output from a speaker of the device that is captured by a microphone of the device during the meeting (block 620). For example, the device may generate a second representation of raw audio output from a speaker of the device that is captured by a microphone of the device during the meeting, as described above.

As further shown in FIG. 6, process 600 includes determining whether the device is broadcasting the meeting audio output based on a result of a comparison of the first representation and the second representation (block 630). For example, the device may determine whether the device is broadcasting the meeting audio output based on a result of a comparison of the first representation and the second representation, as described above.

As further shown in FIG. 6, process 600 includes outputting an indication that the device is broadcasting the meeting audio output (block 640). For example, the device may output an indication that the device is broadcasting the meeting audio output, as described above.

Process 600 may include additional aspects, such as any single aspect or any combination of aspects described below and/or in connection with one or more other processes described elsewhere herein.

In a first aspect, the first representation is a first transcript of the meeting audio output and the second representation is a second transcript of the raw audio output, and the comparison includes a comparison of the first transcript and the second transcript.

In a second aspect, alone or in combination with the first aspect, the comparison uses a similarity algorithm.

In a third aspect, alone or in combination with one or more of the first and second aspects, the determining comprises calculating a similarity score based on the comparison, and determining whether the device is broadcasting the meeting audio output based on whether the similarity score satisfies a similarity threshold.

In a fourth aspect, alone or in combination with one or more of the first through third aspects, process 600 includes training the similarity threshold based on raw audio that is indicated as being broadcast.

In a fifth aspect, alone or in combination with one or more of the first through fourth aspects, the raw audio is from each of multiple attendees.

In a sixth aspect, alone or in combination with one or more of the first through fifth aspects, the indication triggers an alert icon that is displayed to attendees of the meeting.

In a seventh aspect, alone or in combination with one or more of the first through sixth aspects, the raw audio output is captured directly from the microphone without software-level muting or noise cancellation.

In an eighth aspect, alone or in combination with one or more of the first through seventh aspects, the device is a mobile device, a laptop, or a desktop computer, and the meeting software is a video conferencing platform or a voice call application.

In a ninth aspect, alone or in combination with one or more of the first through eighth aspects, process 600 includes repeating the obtaining, generating, determining, and outputting steps for multiple iterations, to continuously monitor and detect whether the device is broadcasting the meeting audio output.

In a tenth aspect, alone or in combination with one or more of the first through ninth aspects, the repeating is performed at predetermined intervals.

Although FIG. 6 shows example blocks of process 600, in some implementations, process 600 includes additional blocks, fewer blocks, different blocks, or differently arranged blocks than those depicted in FIG. 6. Additionally, or alternatively, two or more of the blocks of process 600 may be performed in parallel.

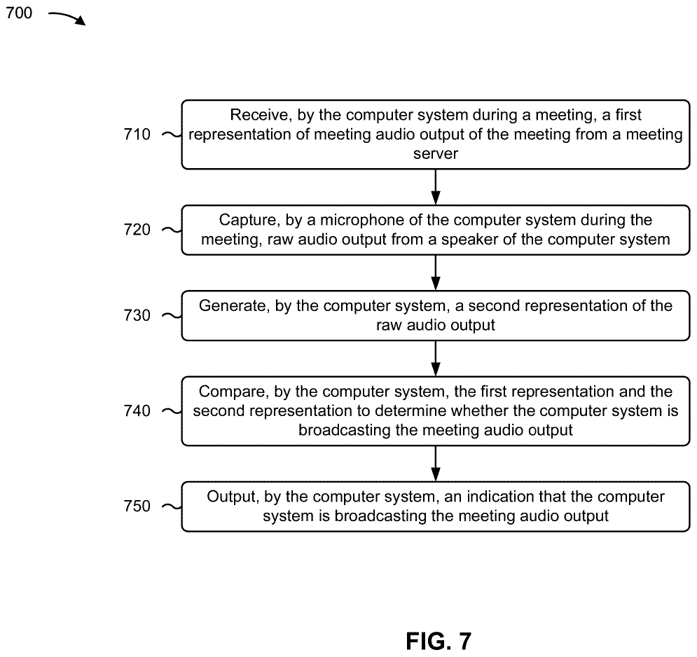

FIG. 7 is a flowchart of an example process 700 associated with detection of audio broadcasting by meeting attendees. One or more process blocks of FIG. 7 are performed by a computer system (e.g., computer 102) and/or by another device or a group of devices separate from or including the computer system.

As shown in FIG. 7, process 700 includes receiving a first representation of meeting audio output of the meeting from a meeting server (block 710). For example, the computer system may receive a first representation of meeting audio output of the meeting from a meeting server, as described above.

As further shown in FIG. 7, process 700 includes capturing raw audio output from a speaker of the computer system (block 720). For example, the computer system may capture raw audio output from a speaker of the computer system, as described above.

As further shown in FIG. 7, process 700 includes generating a second representation of the raw audio output (block 730). For example, the computer system may generate a second representation of the raw audio output, as described above.

As further shown in FIG. 7, process 700 includes comparing the first representation and the second representation to determine whether the computer system is broadcasting the meeting audio output (block 740). For example, the computer system may compare the first representation and the second representation to determine whether the computer system is broadcasting the meeting audio output, as described above.

As further shown in FIG. 7, process 700 includes outputting an indication that the computer system is broadcasting the meeting audio output (block 750). For example, the computer system may output an indication that the computer system is broadcasting the meeting audio output, as described above.

Process 700 may include additional aspects, such as any single aspect or any combination of aspects described below and/or in connection with one or more other processes described elsewhere herein.

In a first aspect, the operations further comprise receiving a declaration from a user of the computer system that indicates that the user is broadcasting the meeting audio output, calculating a similarity score based on the comparison of the first representation and the second representation, and adjusting a similarity threshold based on the similarity score when the declaration is received.

In a second aspect, alone or in combination with the first aspect, the operations further comprise calculating a similarity score based on the comparison of the first representation and the second representation, comparing the similarity score to a similarity threshold, and determining that the computer system is broadcasting the meeting audio output based on the similarity score satisfying the similarity threshold.

In a third aspect, alone or in combination with one or more of the first and second aspects, the first representation is a first transcript and the second representation is a second transcript.

In a fourth aspect, alone or in combination with one or more of the first through third aspects, the operations further comprise displaying an alert icon on a display of the computer system based on receiving an indication that the meeting audio output is being broadcast on another device.

Although FIG. 7 shows example blocks of process 700, in some implementations, process 700 includes additional blocks, fewer blocks, different blocks, or differently arranged blocks than those depicted in FIG. 7. Additionally, or alternatively, two or more of the blocks of process 700 may be performed in parallel.

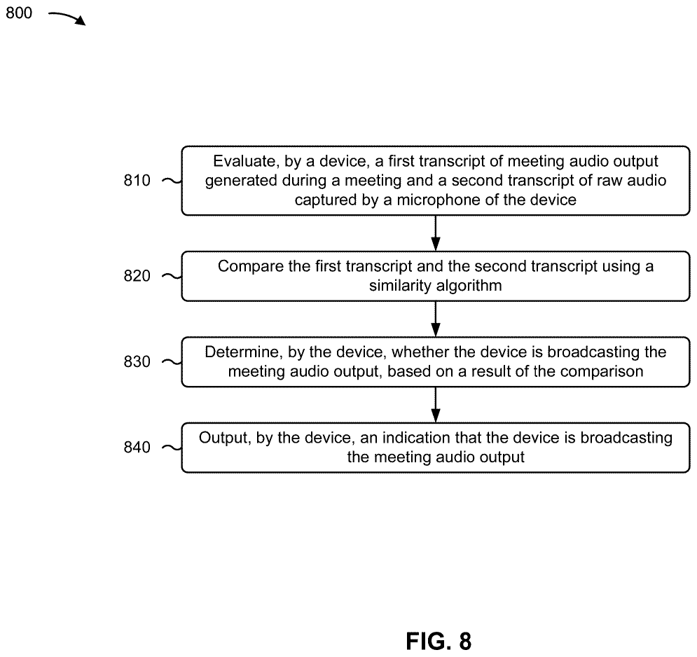

FIG. 8 is a flowchart of an example process 800 associated with detection of audio broadcasting by meeting attendees. One or more process blocks of FIG. 8 are performed by a device (e.g., computer 102) and/or by another device or a group of devices separate from or including the device.

As shown in FIG. 8, process 800 includes evaluating a first transcript of meeting audio output generated during a meeting and a second transcript of raw audio captured by a microphone of the device (block 810). For example, the device may evaluate a first transcript of meeting audio output generated during a meeting and a second transcript of raw audio captured by a microphone of the device, as described above.

As further shown in FIG. 8, process 800 includes comparing the first transcript and the second transcript using a similarity algorithm (block 820). For example, the device may compare the first transcript and the second transcript using a similarity algorithm, as described above.

As further shown in FIG. 8, process 800 includes determining whether the device is broadcasting the meeting audio output, based on a result of the comparison (block 830). For example, the device may determine whether the device is broadcasting the meeting audio output, based on a result of the comparison, as described above.

As further shown in FIG. 8, process 800 includes outputting an indication that the device is broadcasting the meeting audio output (block 840). For example, the device may output an indication that the device is broadcasting the meeting audio output, as described above.

Process 800 may include additional aspects, such as any single aspect or any combination of aspects described below and/or in connection with one or more other processes described elsewhere herein.

In a first aspect, the operations further comprise displaying an alert icon on a display of the device based on receiving an indication that the meeting audio output is being broadcast on another device.

In a second aspect, alone or in combination with the first aspect, the alert icon is displayed in a meeting interface and identifies the other device.

In a third aspect, alone or in combination with one or more of the first and second aspects, the operations further comprise operating the device in multiple environments, and adapting the device to detect broadcasting of audio output in each of the multiple environments.

Although FIG. 8 shows example blocks of process 800, in some implementations, process 800 includes additional blocks, fewer blocks, different blocks, or differently arranged blocks than those depicted in FIG. 8. Additionally, or alternatively, two or more of the blocks of process 800 may be performed in parallel.

The foregoing disclosure provides illustration and description, but is not intended to be exhaustive or to limit the implementations to the precise forms disclosed. Modifications may be made in light of the above disclosure or may be acquired from practice of the implementations. For example, various aspects of this disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

A computer program product embodiment (“CPP embodiment” or “CPP”) is a term used in this disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, RAM, ROM, erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc), or any suitable combination of the foregoing. A computer-readable storage medium, as that term is used in this disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method comprising:
obtaining, by a device, a first representation of meeting audio output generated during a meeting by meeting software;
generating, by the device, a second representation of raw audio output from a speaker of the device that is captured by a microphone of the device during the meeting;
determining, by the device, whether the device is broadcasting the meeting audio output based on a result of a comparison of the first representation and the second representation; and
outputting, by the device, an indication that the device is broadcasting the meeting audio output.

2. The method of claim 1, wherein the first representation is a first transcript of the meeting audio output and the second representation is a second transcript of the raw audio output, and wherein the comparison includes a comparison of the first transcript and the second transcript.

3. The method of claim 1, wherein the comparison uses a similarity algorithm.

4. The method of claim 3, wherein the determining comprises:
calculating a similarity score based on the comparison; and
determining whether the device is broadcasting the meeting audio output based on whether the similarity score satisfies a similarity threshold.

5. The method of claim 4, further comprising:
training the similarity threshold based on raw audio that is indicated as being broadcast.

6. The method of claim 5, wherein the raw audio is from each of multiple attendees.

7. The method of claim 1, wherein the indication triggers an alert icon that is displayed to attendees of the meeting.

8. The method of claim 1, wherein the raw audio output is captured directly from the microphone without software-level muting or noise cancellation.

9. The method of claim 1, wherein the device is a mobile device, a laptop, or a desktop computer, and wherein the meeting software is a video conferencing platform or a voice call application.

10. The method of claim 1, further comprising:
repeating the obtaining, generating, determining, and outputting steps for multiple iterations, to continuously monitor and detect whether the device is broadcasting the meeting audio output.

11. The method of claim 10, wherein the repeating is performed at predetermined intervals.

12. A computer system comprising:
a processor set;
one or more computer-readable storage media; and
program instructions stored on the one or more computer-readable storage media to cause the processor set to perform operations comprising:
receiving, by the computer system during a meeting, a first representation of meeting audio output of the meeting from a meeting server;
capturing, by a microphone of the computer system during the meeting, raw audio output from a speaker of the computer system;
generating, by the computer system, a second representation of the raw audio output;
comparing, by the computer system, the first representation and the second representation to determine whether the computer system is broadcasting the meeting audio output; and
outputting, by the computer system, an indication that the computer system is broadcasting the meeting audio output.

13. The computer system of claim 12, wherein the operations further comprise:
receiving a declaration from a user of the computer system that indicates that the user is broadcasting the meeting audio output;
calculating a similarity score based on the comparing of the first representation and the second representation; and
adjusting a similarity threshold based on the similarity score when the declaration is received.

14. The computer system of claim 12, wherein the operations further comprise:
calculating a similarity score based on the comparing of the first representation and the second representation;
comparing the similarity score to a similarity threshold; and
determining that the computer system is broadcasting the meeting audio output based on the similarity score satisfying the similarity threshold.

15. The computer system of claim 12, wherein the first representation is a first transcript and the second representation is a second transcript.

16. The computer system of claim 12, wherein the operations further comprise:
displaying an alert icon on a display of the computer system based on receiving an indication that the meeting audio output is being broadcast on another device.

17. A computer program product comprising:
one or more computer-readable storage media;
program instructions stored on the one or more computer-readable storage media to perform operations comprising:
evaluating, by a device, a first transcript of meeting audio output generated during a meeting and a second transcript of raw audio captured by a microphone of the device;
comparing the first transcript and the second transcript using a similarity algorithm;
determining, by the device, whether the device is broadcasting the meeting audio output, based on a result of the comparing; and
outputting, by the device, an indication that the device is broadcasting the meeting audio output.

18. The computer program product of claim 17, wherein the operations further comprise:
displaying an alert icon on a display of the device based on receiving an indication that the meeting audio output is being broadcast on another device.

19. The computer program product of claim 18, wherein the alert icon is displayed in a meeting interface and identifies the another device.

20. The computer program product of claim 17, wherein the operations further comprise:
operating the device in multiple environments; and
adapting the device to detect broadcasting of audio output in each of the multiple environments.
